(19) United States
(12) Patent Application Publication
(10) Pub. No.: US 2025/0360627 A1
(43) Pub. Date: Nov. 27, 2025

(54) CALIBRATION OF TOOL AND WORK OBJECT FOR ROBOT

(71) Applicant: ABB SCHWEIZ AG, Baden (CH)

(72) Inventors: Wenbin Li, Shanghai (CN); Qi Lu, Shanghai (CN); Yichao Mao, Hangzhou (CN); Yiming Dong, Shanghai (CN)

(21) Appl. No.: 19/294,938

(22) Filed: Aug. 8, 2025

Related U.S. Application Data
(63) Continuation of application No. PCT/CN2023/075307, filed on Feb. 10, 2023.

(51) Int. Cl. B25J 9/16

(52) U.S. Cl. CPC B25J 9/1692; B25J 9/1653

(57) ABSTRACT

Example embodiments of the present disclosure relate to calibration of a tool and a work object for a robot. The method includes determining a geometry constraint from a set of candidate geometry constraints as a physical closure for the calibration; determining a set of touch points of the tool with the work object based on a performance criterion and an objective function, wherein the objective function is constructed for the tool and the work object based on the selected geometry constraint; and obtaining calibration parameters of the tool and the work object according to the objective function based on observations from the robot with the set of touch points.

### FIELD

Embodiments of the present disclosure generally relate to the field of industrial robots and, in particular, to a method, a computing device and computer readable storage medium for calibration of a tool and a work object for a robot.

### BACKGROUND

Calibration of a tool's coordinate system (i.e., the tool calibration or the so called Tool Center Point (TCP) calibration) and calibration of the work object's coordinate system (i.e., the work object calibration) are two important steps for robot applications. The performance or quality of the tool calibration and the work object calibration directly affects the robot's absolute position accuracy and path accuracy.

Nowadays, the tool calibration and the work object calibration are often considered as two individual steps. Generally, when a tool is attached to the robot hand, a 4 points tool calibration method will conducted first to calibrate the relative position and rotation between the tool and the end point of the robot (hereinafter, also referred to as the robot end point T_{E}). Then, in the actual working task, the work object is often defined by the robot holding the attached tool and touching three points in the working space of the robot and then constructing the work object. Such procedure of defining the work object problematically treats the robot tool as an error free observation. Therefore, the tool error gained from the tool calibration is propagated and accumulated into the work object calibration. In this way, error propagation may be occurred between the tool calibration and the work object calibration, which may limit the robot performance such as the overall robot absolute position accuracy and path accuracy.

### SUMMARY

In general, example embodiments of the present disclosure provide a solution for calibration of a tool and a work object for the robot that may calibrate both the tool and the work object at the same time. That is, the tool and the work object may be calibrated through a single process rather than two separate processes.

In a first aspect, there is provided a method for calibration of a tool and a work object for a robot. The method includes determining a geometry constraint from a set of candidate geometry constraints as a physical closure for the calibration; determining a set of touch points of the tool with the work object based on a performance criterion and an objective function, wherein the objective function is constructed for the tool and the work object based on the selected geometry constraint; and obtaining calibration parameters of the tool and the work object according to the objective function based on observations from the robot with the set of touch points.

In one implementation, determining the geometry constraint includes providing the set of candidate geometry constraints when application of the robot is setup; determining whether each of the set of candidate geometry constraints forms the physical closure; and selecting the geometry constraint from those geometry constraints form the physical closure.

In one implementation, the objective function is formed with four vectors formed from a base of the robot, an end point of the robot, a touch point where the end point of the robot touching the work object, and an origin point of the work object.

In one implementation, the objective function is constructed by determining a first vector from the base of the robot to the end point of the robot, a second vector from the end point of the robot to the touch point, a third vector from the touch point to the origin point of the work object and a fourth vector from the origin point of the work object to the base of the robot in case that the tool is an on-hand tool and the work object is a fixed work object; determining a first vector from the base of the robot to the end point of the robot, a second vector from the end point of the robot to the origin point of the work object, a third vector from the origin point of the work object to the touch point and a fourth vector from the touch point to the base of the robot in case that the tool is a fixed tool and the work object is an on-hand work object; and constructing the objective function by sequentially adding the first vector, the second vector, the third vector and the fourth vector to form the physical closure.

In one implementation, determining the set of touch points of the tool includes receiving a user input of a first number of desired touch points of the robot; generating a second number of candidate touch points of the robot, wherein the second number is multiple times larger than the first number; dividing the second number of candidate touch points into a plurality of subsets of candidate touch points each containing the first number of candidate touch points; determining a precision error indicating value of each subset of candidate touch points; and selecting the subset of candidate touch points with a minimum precision error indicating value as the set of touch points.

In one implementation, the method further includes determining whether each subset of the candidate poses is reachable by the robot; eliminating a subset of candidate poses from the plurality of subsets of candidate poses in response to determining that the subset of candidate poses is not reachable.

In one implementation, obtaining calibration parameters of the tool and the work object includes controlling the robot to touch the work object with the set of touch points; obtaining the observations from the robot in response to the touching; and solving the objective function based on the observations.

In one implementation, the method further includes determining a calibration result of the tool and the work object; determining whether the calibration result meets the performance criterion; and determining another set of touch points of the tool with the work object in response to determining that the calibration result does not meet the performance criterion.

In one implementation, the performance criterion includes a precision error indicating value of the set of touch points being lower than a certain threshold.

In a second aspect, there is provided a computing device. The computing device includes at least one processor; and at least one memory including computer program codes; wherein the at least one memory and the computer program codes are configured to, with the at least one processor, cause the computing device to implement the method according to the above aspect.

In a third aspect, there is provided a robot system comprising the robot; the tool; the work object on which the tool moves; and the computing device configured for calibration of the tool and the work object according to the method of the above aspect.

In a fourth aspect, there is provided a non-transitory computer readable medium comprising program instructions for causing an apparatus to perform at least the method according to the above aspect.

With the solution of the present disclosure, both the tool and the work object of a robot may be calibrated at the same time and thus error propagation may be reduced or optimized and position accuracy and path accuracy of the robot may be improved. In particular, in some aspects, the geometry constraint may be defined for the calibration of the tool and work object at the same time and ensures the error optimization in both tool and work object calibrations. In some further aspects of this invention, the geometry constraint based objective function may be automatically formed so that optimized data sampling may be conducted and the tool and work object calibration result may be optimized by solving the objective function, which may significantly reduce the front-end engineers' work, and at same time it will also ensure the overall calibration performance. In some still further aspects, an indicator for the calibration performance such as the Dilution of Precision (DOP) value may be used to evaluate the quality of the calibration so as to better indicate the difference between the observed value (data sampling for calibration) and the estimated value (calibrated results), and it is not related to the error or the ground truth value.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example robot system in which example embodiments of the present disclosure may be implemented.

FIG. 2 shows a process for calibration of the tool and the work object for the robot according to some example embodiments of the present disclosure.

FIG. 3 illustrates a detailed process of selecting the geometry constraint according to some example embodiments of the present disclosure.

FIG. 4 (a) illustrates an example of a configuration of an on-hand tool and a fixed work object, and FIG. 4 (b) illustrates another example of a configuration of a fixed tool and an on-hand work object.

FIG. 5 illustrates a detailed process of determining the set of touch points according to some example embodiments of the present disclosure.

FIGS. 6 (a) to 6 (c) illustrate examples of the touch points on a calibration ball.

FIG. 7 is a simplified block diagram of a computing device that is suitable for implementing example embodiments of the present disclosure.

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

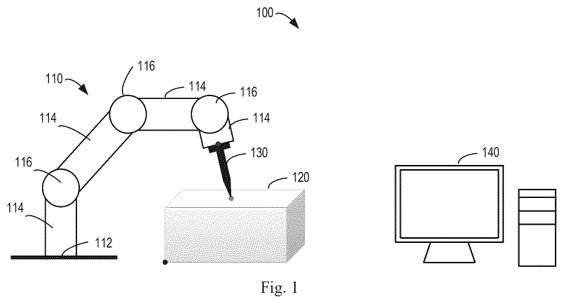

FIG. 1 illustrates an example robot system 100 in which example embodiments of the present disclosure may be implemented. The robot system 100 may include a robot 110, a work object 120 on which the robot 110 is operated, a tool 130 with which the robot 110 is operated on the work object 120, and a computing device 140 for controlling the robot 110 to operate on the work object 120. For calibration, one or more calibration balls 150 (not shown in FIG. 1) may be installed on the work object 120.

The robot 110 may have one or more degrees of freedom. For example, according to certain embodiments, the robot 110 may have at least three axes, including, but not limited to, robots having six degrees of freedom. As shown in FIG. 1, the robot 110 may include a base 112 which is installed at a certain position, and one or more robot arms 114 connected by robot joints 116. In some embodiments, the tool 130 may be an on-hand tool that is attached to the last robot arm 114, as shown in FIG. 1. The last robot arm 114 may also be called as a robot hand to hold the tool 130 and move the tool 130 on the work object 120. In this case, the work object 120 is usually a fixed work object. In some other embodiments, the tool 130 may be a fixed tool that is fixed to a certain position (now shown in FIG. 1). In this case, the robot hand may hold the work object 120 and move the work object 120 on the tool 130. That is, the work object 120 is an on-hand work object.

The tool 130, also referred to as an end effector, may be operatively positioned on the end of the robot 110 such that a work envelope or workspace of the robot 110 utilizing the tool 130 may enable the tool 130 to perform work on the work object 120. A variety of different types of tool 130 may be utilized by the robot system 100, including, for example, a tool 130 that is a painting or coating spraying device or tool, welding gun, gripper(s), fixture, spotlight(s), laser emitter, conveyor, and/or a milling or drilling tool, among other types of tools or devices that can perform work on, grip, displace, and/or perform other functions relating to the work object 120.

During operation of the robot 110, the tool 130 may touch a set of points on the work object 120 so as to finish a certain work task. The touch point of the tool 130 on the work object 120 is the tool to be calibrated, and the work object 120 should also be calibrated. Here in the present disclosure, “touch” or “touching” does not necessarily mean the interaction between two solid pieces or so-called “hard touch”. Sometimes, “touch” or “touching” may mean interaction between one solid piece and another non-solid piece or so-called “soft touch”. For example, if the tool 130 includes a laser emitter, “touch” herein may refer to the laser emitted from the laser emitter pointing to a set of points on the work object 120.

The computing device 140 may be connected with the robot 110 in a wired or wireless manner and may be configured to execute program instructions by processors such as microprocessors therein to perform tasks associated with operating the robot 110 directly or through a separate controller as described later. For example, the computing device 140 may be local to any or all of the robot 110, the work object 120 and the tool 130. For another example, the computer device 140 may be a cloud device to any or all of the robot 110, the work object 120 and the tool 130. The program instructions may be in the form of software stored in one or more memories or may be in the form of any one or combination of software, firmware and hardware. In the present disclosure, the computing device 140 may further determine the set of the touch points of the tool 130 on the work object 120 so as to perform the tool and the work object calibration at the same time in advance.

It should be appreciated that the robot system 100 or the robot 110 may also include some other components. For example, the robot 110 may also include an actuating mechanism for actuating the robot 110. The robot 110 may further include one or more sensors that can be used in connection with observing the robot 110, including the robot 110 and the work object 120 or parts on which the robot 110 and/or the tool 130 are performing work. Examples of such sensors may include imaging capturing devices, microphones, position sensors, proximity sensors, accelerometers, motion sensors, and/or force sensors, among other types of sensors and sensing devices. The sensors may output data or information that is utilized by the computing device 140 to control the robot 110 in the performance of work on the work object 120.

Furthermore, the robot system 100 or the robot 110 may include a separate controller that directly controls the movement of the robot 110 according to instructions from the computing device 140, for example.

As stated above, the tool calibration and the work object calibration should be performed before actual robot applications. To this end, in the present disclosure, it is provided a solution for calibration of tool and work object for the robot 110, in which by selecting and applying a specific geometry constraint to the calibration of the tool and work object, the tool calibration and the work object calibration may be achieved at the same time and error propagation is reduced or eliminated. Furthermore, in some embodiments, by constructing and solving an objective function so as to implement the whole calibration procedure in an automatic manner, the present disclosure significantly reduces the front-end engineers' time consuming work on jogging the robot for data sampling and calibration so as to ensure the overall calibration performance. In addition, in some embodiments, the present disclosure provides a proper performance indicator such as the DOP value to evaluate the performance of the calibration.

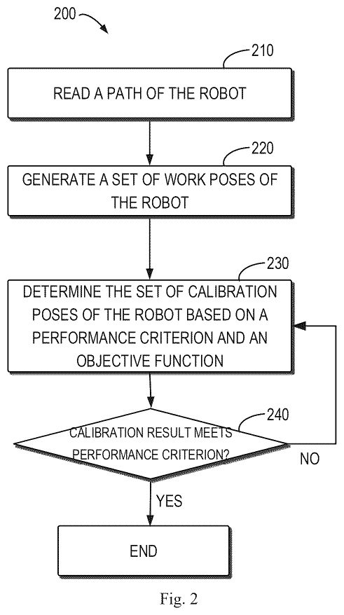

Reference is now made to FIG. 2, which shows a process 200 for calibration of the tool and the work object for the robot 110 according to some example embodiments of the present disclosure. For the purpose of discussion, the process 200 will be described with reference to FIG. 1. The process 200 may be implemented by or in the computing device 140.

In the process 200, at block 210, the computing device 140 may determine a geometry constraint from a set of candidate geometry constraints as a physical closure for the calibration of the tool and the work object 120.

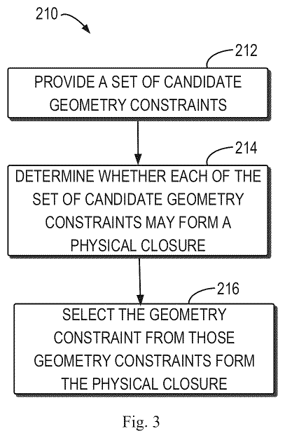

FIG. 3 illustrates a detailed process of the block 210 according to some example embodiments of the present disclosure.

As shown in FIG. 3, at block 212, the set of candidate geometry constraints may be provided for selecting when the application of the robot is setup. For example, a user interactive tool or widget may be provided on the computing device 140 for the user or operator of the robot 110 to choose a proper geometry constraint used in the calibration. The set of candidate geometry constraints may include some typical geometry constraints such as cuboid, cylinder, sphere, etc., each of which may be applicable to different applications. Furthermore, if 3D model is available, the geometry constraints may also include some customized 3D objects.

At block 214, it may be determined whether each of the set of candidate geometry constraints may form a physical closure. Depending on whether the tool is an on-hand tool or a fixed tool, the unknown parameters to be solved are different. In either case, the selected geometry constraint should form a physical closure such that the unknown parameters are identifiable.

At block 216, the geometry constraint may be selected from those geometry constraints form the physical closure.

The selection of the geometry constraint in block 210 may be experimental for the user or operator, or may be automatically performed by the computing device 140 according to computer programs stored therein.

Continuing with FIG. 2, at block 220, the computing device 140 may determine a set of touch points of the tool 130 with the work object 120 based on a performance criterion and an objective function constructed for the tool and the work object based on the selected geometry constraint.

Basically, the objective function based on the selected geometry constrain can be designed as:

$$\sum G ( tcp , wobj ) = 0 \qquad ( 1 )$$

where:
G(x) is the objective function based on the selected geometry constraint, and tcp, wobj. is the tool and work object to be calibrated, respectively.

The objective function G(x) may be formed with four vectors based on a base of the robot (T₀), an end point of the robot (T_{E}), a touch point (P) where the end point of the robot (T_{E}) touching the work object 120, and an origin point (W₀) of the work object 120. The four vectors may form a physical closure in the real world. To solve the object function, it is to find the unknown parameters that make the objective function to be zero.

As stated above, for on-hand tool and fixed tool, the unknown parameters are different and thus different objective function may be constructed.

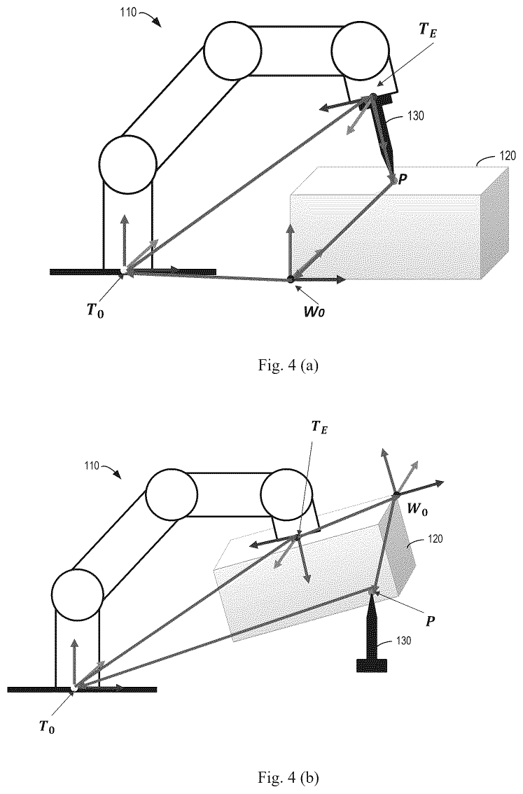

FIG. 4 (a) illustrates an example of a configuration of an on-hand tool and a fixed work object, and FIG. 4 (b) illustrates another example of a configuration of a fixed tool and an on-hand work object.

In the illustrated on-hand tool and fixed work object setup of FIG. 4 (a), a first vector is formed from the base of the robot 110 (T₀) to the end point of the robot 110 (T_{E}), a second vector is formed from the end point of the robot 110 (T_{E}) to the touch point (P), a third vector is formed from the touch point (P) to the origin point (W₀) of the work object 120 and a fourth vector is formed from the origin point (W₀) of the work object 120 to the base of the robot 110 (T₀). Then, the objective function may be constructed by sequentially adding the first vector, the second vector, the third vector and the fourth vector to form the physical closure.

In this case, the unknown parameters to be identified are the tool and work object, which is equivalent to obtaining the offset between the end point of the robot 110 (T_{E}) and the Touch Point P and the relative position between the base of the robot 110 (T₀) and the origin point (W₀) of the work object 120.

In the illustrated fixed tool and on-hand work object setup of FIG. 4 (b), a first vector is formed from the base of the robot 110 (T₀) to the end point of the robot 110 (T_{E}), a second vector is formed from the end point of the robot 110 (T_{E}) to the origin point (W₀) of the work object 120, a third vector is formed from the origin point (W₀) of the work object 120 to the touch point (P) and a fourth vector is formed from the touch point (P) to the base of the robot 110 (T₀). Then, the objective function may be constructed by sequentially adding the first vector, the second vector, the third vector and the fourth vector to form the physical closure.

In this case, the unknown parameters to be identified will be the offset between the end point of the robot 110 (T_{E}) and the origin point (W₀) of the work object 120 and the relative position between the base of the robot 110 (T₀) and the fixed Touch Point P.

One-dimensional measurements device, such as laser, LVTD, etc., that provides distance information between the end point of the robot and surface or certain point on the work object can also finish the mentioned closure.

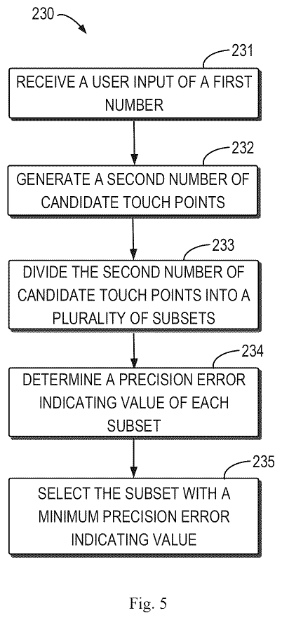

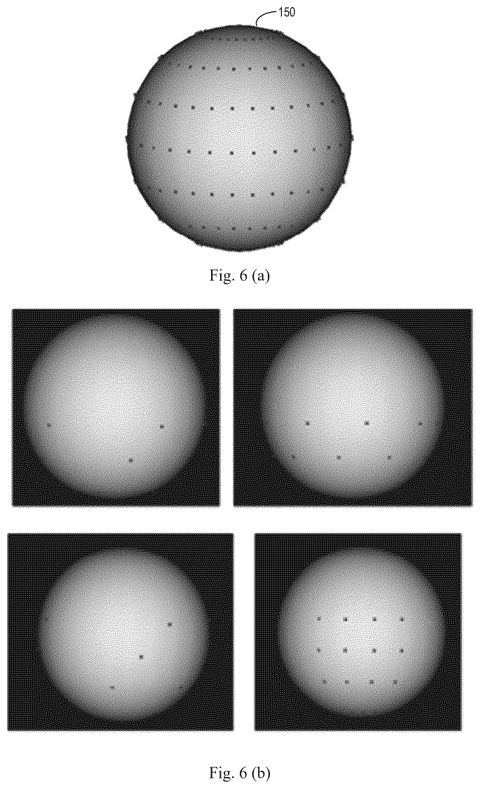

FIG. 5 illustrates a detailed process for determining the set of touch points according to some example embodiments of the present disclosure. FIGS. 6 (a) to 6 (c) illustrate examples of the touch points on a calibration ball 150.

As shown in FIG. 5, at block 231, the computing device 140 may receive a user input of a first number (N) of desired touch points of the robot 110. For example, the computing device 140 may include a user interface through which the user or operator of the robot 110 may input some initial information to the computing device 140. Herein, the initial information may include the number of desired touch points (i.e., the number of poses) of the robot 110 on the calibration ball 150. Depending on the work to be done, the number of desired touch points of the robot 110 may be varied. In some embodiments, the initial information may further include initial information of the tool and the work object 120 for calibration.

At block 232, the computing device 140 may generate a second number (M) of candidate touch points of the robot 110. The second number is usually multiple times larger than the first number. For example, if the first number is 10, the second number may be 30 or larger. The second number may be input by the user or automatically generated by the computing device 140.

The basic rule of generation of the candidate points is to evenly cover the whole surface of the calibration ball 150 as shown in FIG. 6 (a). In some further embodiments, additional information, such as 3D environmental model, the robot's reaching ability, the candidate point locations may be further refined according to the environment or robot operating limitations.

At block 233, the second number of candidate touch points may be divided into a plurality of subsets of candidate touch points each containing the first number of candidate touch points. Similarly, the candidate touch points should be evenly divided such that each subset of candidate touch points may evenly cover the surface of the calibration ball 150. As illustrated in FIG. 6 (b), four subsets of candidate touch points are generated.

In some embodiments, after getting the plurality of subsets of candidate touch points, the block 230 may further include determining the reachability of each subset.

In particular, it may be checked whether each subset of the candidate touch points is reachable by the robot 110. Due to the installation of the robot 110 or the capability of the robot 110, some of the touch points on the calibration ball 150 may be not able to or difficult to reach. Therefore, before the final selection, such subsets of candidate touch points may be eliminated from the plurality of subsets of candidate touch points.

At block 234, a precision error indicating value of each subset of candidate touch points may be determined.

The precision error indicating may indicate error of precision of the calibration or performance criterion of the calibration. In some embodiments of the present disclosure, the DOP value is used as the performance criterion of the calibration. The DOP value was conventionally used in the field of Global Navigation Satellite System such as the GPS. In the present disclosure, the DOP value is introduced for performance evaluation of the calibration.

Mathematically, the DOP value may be used for least square optimization. For each subset of the candidate touch points, the DOP value may be determined by the following equations.

$$Ax = L \qquad ( 2 )$$

### Where:

A is a design matrix;
x is the unknown parameters; and
L is the observation matrix.

The calibration result is the best fitted result:

$$\hat{x} = {( {A}^{T} A )}^{- 1} L \qquad ( 3 )$$

The common calibration performance indicator, residual r will be

$$r = L - A \hat{x} \qquad ( 4 )$$

Calibration Error ε, which is the difference between the fitted result \hat{x} and ground truth \dot{x}, (L−A\dot{x}=0), is the most straightforward performance indicator for tool or work object calibration, but often unobservable.

$$ε = \hat{x} - \dot{x} \qquad ( 5 )$$

As shown in above the residual r is not related to error ε, using residual as performance indicator for tool calibration can be problematic, since that are possibility that a bad calibration practice has large error in the calibrated result while only have small residuals.

In least square system as the above equation (2), we have the covariance of unknown x as:

$$cov ( x ) = {( {A}^{T} A )}^{- 1} = [ \begin{matrix}{c}_{11} & {c}_{12} & … & {c}_{1 n} \\ {c}_{21} & {c}_{22} & … & {c}_{2 n} \\ ⋮ & ⋮ & ⋱ & ⋮ \\ {c}_{n 1} & {c}_{n 2} & … & {c}_{nn}\end{matrix} ] \qquad ( 6 )$$

The DOP value is defined as

$$DOP = \sqrt{( {c}_{11}^{2} + {c}_{22}^{2} + … + {c}_{nn}^{2} )} \qquad ( 7 )$$

Small DOP value indicates better system robustness and high probability of good result; thus, it can be used as an indicator for tool calibration.

Since the DOP value indicates system stability, a better DOP value (smaller) means higher probability of less error. Such connection between the DOP value and errors makes DOP value a more reasonable indicator than residual.

The DOP value can also be used as a feedback to improve the calibration procedure. The diagonal elements of the covariance matrix (the above equation (6)) can be viewed as a single DOP value for the corresponding unknown parameters. So, a larger diagonal element in the covariance matrix indicates system instability for its corresponding unknown parameters.

Therefore, the DOP value may act as a measure of the “goodness” of least square system with given observation. A better (lower) DOP value indicates the probability of a more accurate solution, from geometric considerations.

The algorithm will go through all the subsets of the N-point candidate touch points and calculate its corresponding DOP value. Thus, the DOP value may act as a mathematical tool to estimate the system stability. As smaller DOP value indicates high system stability and better chance of good performance, the algorithm will select the subset with the smallest DOP value as the suggested touch point distribution to the users.

Then at block 235, the subset of candidate touch points with a minimum DOP value may be selected as the set of touch points, as shown in FIG. 6 (c).

In the process of FIG. 5, it may further include a block for trade-off of the operating time and accuracy of the calibration.

In particular, at block 231, if the user input of the first number N is received, the computing device 140 may automatically generate several other numbers N′ around the first number N, which may be called as the shadow first numbers. For example, if the input first number N is 10, the computing device 140 may automatically generate several shadow first numbers N′ larger than and smaller than the first number N, such as 5 and 15, etc.

Then, the same process of blocks 232 to 235 may be automatically performed for the several shadow first numbers N′ to get the best DOP value for each shadow first number. Meanwhile, the operating time consumed for the first number N of touch points and the shadow first numbers N′ of touch points may be obtained. For example, the operating time may be simply got by multiplying N or N′ with the cycle time for operating each touch point of the robot 110. Here, the cycle time for operating each touch point of the robot 110 may be a predefined parameter of the robot 110.

Thus, after block 235, the computing device 140 may get a correspondence between the first number N and the shadow first numbers N′ with their respective operating time. The correspondence may be shown on the user interface of the computing device 140 for selection by the user or operator or be automatically selected by the computing device 140.

Till now, the touch points of the robot 110 may be determined for the calibration. Then, the computing device 140 may control the robot 110 to touch the work object 120 with the set of touch points.

Furthermore, in response to the touching, observations from the robot 110 may be obtained, for example, from the sensors mentioned above. The observations may include the translation and rotation values of the positions of the robot 110 in each of the optimized robot poses.

Based on the observations, at block 230, the computing device 140 may obtaining calibration parameters of the tool 130 and the work object 120 according to the objective function. The calibration parameters may be the unknown parameters described above in connection with FIG. 4 (a) and FIG. 4 (b) and the equations (1) to (7).

In some further embodiments, the process 200 may further include a block 240 at which the calibration result of block 230 may be determined. Then, it may be determined whether the calibration result meets the performance criterion. Herein, the performance criterion may also be DOP based. For example, it may be determined whether the DOP value of the set of touch points is lower than a certain threshold. The threshold may be an experimental value preset in the computing device 140.

If it is determined that the calibration result does not meet the performance criterion, for example, the DOP value of the set of touch points is larger than or equal to the threshold, the process 200 may turn to block 230 to determine another set of touch points. Otherwise, the calibration process may be ended and the calibration result may be outputted.

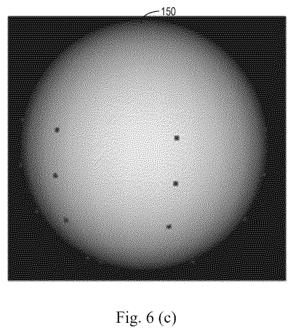

FIG. 7 is a simplified block diagram of a computing device 700 that is suitable for implementing example embodiments of the present disclosure. The computing device 700 may be provided to implement the computing device 140 as shown in FIG. 1. As shown, the computing device 700 includes one or more processors 710, one or more memories 720 coupled to the processor 710, and one or more communication modules 740 coupled to the processor 710.

The communication module 740 is for bidirectional communications. The communication module 740 may represent any interface that is necessary for communication with other elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The computing device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital versatile disc (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the memory, e.g., ROM 724. The processor 710 may perform any suitable actions and processing by loading the program 730 into the RAM 722.

The example embodiments of the present disclosure may be implemented by means of the program 730 so that the computing device 700 may perform any process of the disclosure as discussed with reference to FIGS. 2 to 6. The example embodiments of the present disclosure may also be implemented by hardware or by a combination of software and hardware.

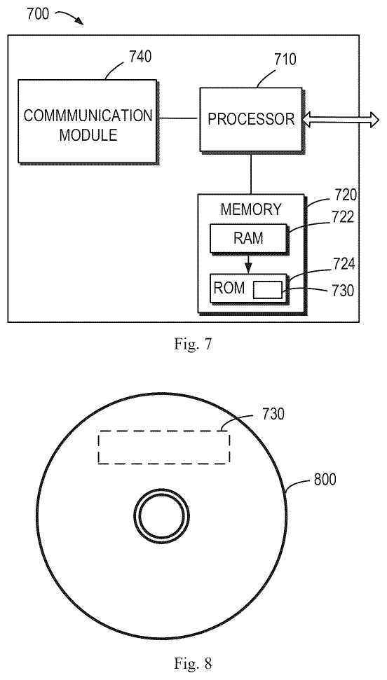

In some example embodiments, the program 730 may be tangibly contained in a computer readable medium which may be included in the computing device 700 (such as in the memory 720) or other storage devices that are accessible by the computing device 700. The computing device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process 200 as described above with reference to FIGS. 2-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for calibration of a tool and a work object for a robot, comprising:
determining a geometry constraint from a set of candidate geometry constraints as a physical closure for the calibration;
determining a set of touch points of the tool with the work object based on a performance criterion and an objective function, wherein the objective function is constructed for the tool and the work object based on the determined geometry constraint; and
obtaining calibration parameters of the tool and the work object according to the objective function based on observations from the robot with the set of touch points.

2. The method of claim 1, wherein determining the geometry constraint comprises:
providing the set of candidate geometry constraints when application of the robot is setup;
determining whether each of the set of candidate geometry constraints forms the physical closure; and
selecting the geometry constraint from those geometry constraints form the physical closure.

3. The method of claim 1, wherein the objective function is formed with four vectors formed from a base of the robot, an end point of the robot, a touch point where the end point of the robot touching the work object, and an origin point of the work object.

4. The method of claim 3, wherein the objective function is constructed by:
determining a first vector from the base of the robot to the end point of the robot, a second vector from the end point of the robot to the touch point, a third vector from the touch point to the origin point of the work object and a fourth vector from the origin point of the work object to the base of the robot, in case that the tool is an on-hand tool and the work object is a fixed work object;
determining a first vector from the base of the robot to the end point of the robot, a second vector from the end point of the robot to the origin point of the work object, a third vector from the origin point of the work object to the touch point and a fourth vector from the touch point to the base of the robot in case that the tool is a fixed tool and the work object is an on-hand work object; and
constructing the objective function by sequentially adding the first vector, the second vector, the third vector and the fourth vector to form the physical closure.

5. The method of claim 1, wherein determining the set of touch points of the tool comprises:
receiving a user input of a first number of desired touch points of the robot;
generating a second number of candidate touch points of the robot, wherein the second number is multiple times larger than the first number;
dividing the second number of candidate touch points into a plurality of subsets of candidate touch points each containing the first number of candidate touch points;
determining a precision error indicating value of each subset of candidate touch points; and
selecting the subset of candidate touch points with a minimum precision error indicating value as the set of touch points.

6. The method of claim 5, further comprising:
determining whether each subset of the candidate touch points is reachable by the robot; and
eliminating a subset of candidate touch points from the plurality of subsets of candidate touch points in response to determining that the subset of candidate touch points is not reachable.

7. The method of claim 1, wherein obtaining calibration parameters of the tool and the work object comprises:
controlling the robot to touch the work object with the set of touch points;
obtaining the observations from the robot in response to the robot touching the work object; and
solving the objective function based on the observations.

8. The method of claim 1, further comprising:
determining a calibration result of the tool and the work object;
determining whether the calibration result meets the performance criterion; and
determining another set of touch points of the tool with the work object in response to determining that the calibration result does not meet the performance criterion.

9. The method of claim 8, wherein the performance criterion includes a precision error indicating value of the set of touch points being lower than a certain threshold.

10. A computing device, comprising:
at least one processor; and
at least one memory including computer program codes;
wherein the at least one memory and the computer program codes are configured to, with the at least one processor, cause the computing device to implement the method of claim 1.

11. A robot system comprising:
the robot;
the tool;
the work object on which the tool moves; and
a computing device configured for calibration of the tool and the work object according to the method of claim 1.

12. A non-transitory computer readable medium comprising program instructions for causing an apparatus to perform the method of claim 1.
